(19) United States
(12) Patent Application Publication
(10) Pub. No.: US 2006/0056850 A1
(43) Pub. Date: Mar. 16, 2006

(54) Single width LC bi-directional transceiver

(75) Inventors: Kirk Cook, Lyons, CO (US); James Duncan, Loveland, CO (US); Eric Larson, Boulder, CO (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(73) Assignee: Infineon Technologies North America Corp.

(21) Appl. No.: 10/933,089

(22) Filed: Sep. 2, 2004

(51) Int. Cl. H04B 10/00

(52) U.S. Cl. 398/117

(57) ABSTRACT

A bi-directional transceiver comprises a housing, a flange coupled to the housing, and only one LC receptacle coupled to the housing. A width of the housing is less than 9.2 mm, and a width of the flange is less than 9.5 mm.

### BACKGROUND

Fiber optic transceivers are used in a variety of applications, including storage area networks (SANs), local area networks (LANs), Fibre Channel, Gigabit Ethernet, and synchronous optical network (SONET) applications. Fiber optic transceivers can be used as the network interface in mainframe computers, workstations, servers, and storage devices. Fiber optic transceivers can also be used in a broad range of network devices, such as bridges, routers, hubs, and local and wide area switches.

Fiber optic transceivers include a fiber optic receiver and a fiber optic transmitter. The fiber optic receiver converts optical serial data to electrical serial data and the fiber optic transmitter converts electrical serial data to optical serial data. A majority of fiber optic transceivers include power control circuits, diagnostic circuits, and other circuits for enhancing the functionality of the fiber optic transceivers.

One type of fiber optic transceiver is a bi-directional transceiver. A bi-directional transceiver has the capability of transmitting and receiving full duplex communications on a single fiber optic cable. A single fiber concept saves overall system costs by eliminating one fiber, allowing for doubling of capacity without installing new fibers, and simplifying fiber management. Because a bi-directional transceiver can transmit and receive signals on a single fiber optic cable, a bidirectional transceiver requires only one receptacle for plugging in a fiber optic cable. One type of fiber optic receptacle is an LC receptacle. An LC receptacle is a high density connector for fiber optic applications. Typically, small form factor pluggable transceivers are designed for two LC receptacles, one for transmitting and one for receiving, as specified in “Cooperation Agreement for Small Form-factor Pluggable Transceivers,” as executed on Sep. 14, 2000 (herein “the Cooperation Agreement”), which is incorporated herein in its entirety. The Cooperation Agreement is part of a small form factor pluggable (SFP) transceiver multi-source agreement for establishing internationally compatible sources of pluggable fiber optic transceivers in support of established standards for fiber optic systems. Specifically, the Cooperation Agreement sets forth transceiver package dimensions, cage and electrical connector specifications, host circuit board layouts, electrical interface specifications and front panel bezel requirements that are followed by each party.

Port density, which is the number of fiber optic cables that can be installed within a fixed area, is an important consideration to customers of fiber optic transceivers. Increasing port density reduces the cost of implementing fiber optic transceiver systems.

### SUMMARY

One embodiment of the invention provides a bi-directional transceiver. The bi-directional transceiver comprises a housing, a flange coupled to the housing, and only one LC receptacle coupled to the housing. A width of the housing is less than 9.2 mm, and a width of the flange is less than 9.5 mm.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 is a top view of one embodiment of a bi-directional transceiver.

FIG. 2 is a front side view of one embodiment of a bi-directional transceiver.

FIG. 3 is a side view of one embodiment of a bi-directional transceiver.

FIG. 4 is a partial front view of one embodiment of a host device for receiving bi-directional transceivers.

### DETAILED DESCRIPTION

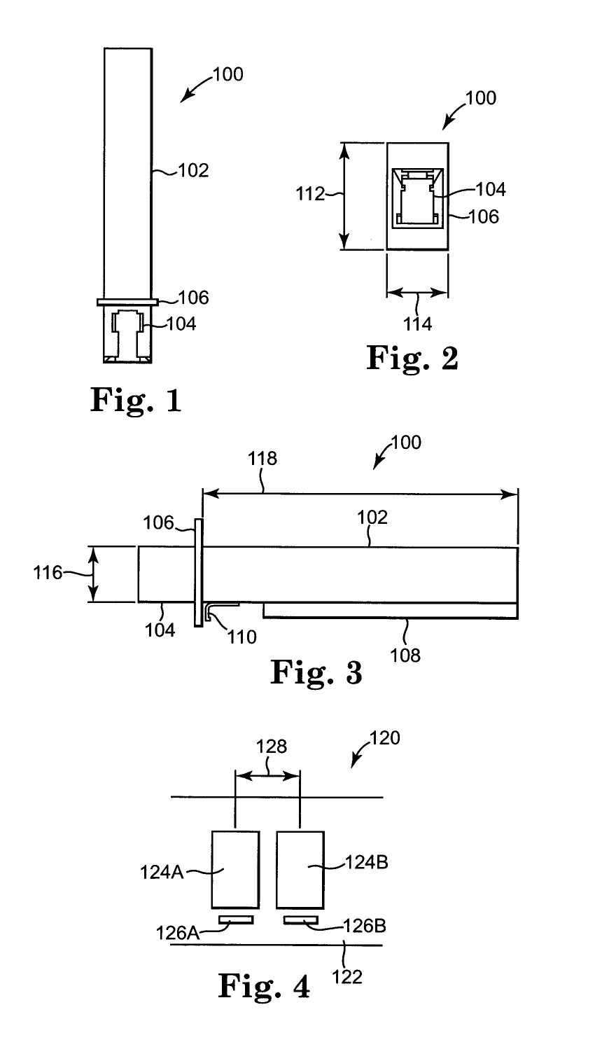

FIG. 1 is a top view of one embodiment of a bi-directional transceiver 100. Bi-directional transceiver 100 includes a housing 102, a flange 106, and an LC receptacle 104. Housing 102 is coupled to flange 106 and LC receptacle 104. In one embodiment, bi-directional transceiver 100 is a pluggable bi-directional fiber optic transceiver for removably coupling to a network device, such as a network bridge, router, hub, local or wide area switch, network interface, etc. In another embodiment, bi-directional transceiver 100 is coupled (e.g., soldered) to an interface board of a host device. In one embodiment, bi-directional transceiver 100 has substantially the same functionality as a standard small form factor pluggable (SFP) transceiver as described in the Cooperation Agreement, except bi-directional transceiver 100 has a smaller form factor that allows customers to increase their port density by up to 100%.

Housing 102 encloses the circuits of bi-directional transceiver 100, including in one embodiment, a transmitter, a receiver, power control circuits, diagnostic circuits, and other circuits. In one form of the invention, housing 102 is made of metal, plastic, or other suitable material.

In one embodiment, flange 106 comprises metal and provides protection for bi-directional transceiver 100 against electromagnetic interference (EMI) when bi-directional transceiver 100 is installed in a host. In other embodiments, flange 106 comprises another suitable material.

LC receptacle 104 is a receptacle for receiving a single fiber optic cable. LC receptacle 104 is a high density connector for fiber optic applications. In one embodiment, LC receptacle 104 complies with the Fiber Optic Connector Intermateability Standard (FOCIS), Telecommunications Industry Association (TIA)/Electronics Industries Alliance (EIA) FOCIS-10 (TIA/EIA-604-10) standard.

FIG. 2 is a front side view of one embodiment of bi-directional transceiver 100. In one embodiment, with bi-directional transceiver 100 installed in a host device, LC receptacle 104 is positioned at an outside edge of the host device to provide easy access to plug a fiber optic cable into LC receptacle 104. In one form of the invention, flange 106 has a height 112 within the range of 12-18 mm, such as 16.25 mm, and a width 114 within the range of 8.5-9.5 mm, such as 9.2 mm.

FIG. 3 is a side view of one embodiment of bi-directional transceiver 100. In addition to housing 102, LC receptacle 104, and flange 106, bi-directional transceiver 100 also includes card edge connector 108 and latch 110. Card edge connector 108 and latch 110 are coupled to housing 102. In one embodiment, housing 102 has a length 118 within the range of 45-49 mm, such as 47.46 mm, and a height 116 within the range of 8-9 mm, such as 8.79 mm.

Card edge connector 108 provides an interface for removably electrically coupling bidirectional transceiver 100 to a host device. Card edge connector 108 can be positioned on any side of housing 102 and can be any suitable length. In other embodiments, other interfaces, such as pins to solder to a host device interface board, can be used in place of card edge connector 108.

Latch 110 is used to removably mechanically couple bi-directional transceiver 100 to a host device. In other embodiments, other suitable latches can be used, such as those described in other multi-source agreements.

FIG. 4 is a partial front view of one embodiment of a host device 120 for receiving bi-directional transceivers 100. In one embodiment, host device 120 is part of a network device, such as a bridge, router, hub, local or wide area switch, or network interface. Host device 120 includes a front bezel or faceplate 122 with openings 124A and 124B therein for receiving bi-directional transceivers 100. Host device 120 also includes openings 126A and 126B in faceplate 122 underneath openings 124A and 124B, respectively, for receiving latches 110 of bi-directional transceivers 100. In one embodiment, the center to center spacing 128 between openings 124A and 124B is within the range of 9-10 mm, such as 9.7 mm.

With bi-directional transceiver 100 installed in opening 124A or 124B, flange 106 contacts faceplate 122 and latch 110 contacts opening 126A or 126B, respectively. In one form of the invention, faceplate 122 comprises metal and flange 106 comprises metal, such that with bidirectional transceiver 100 installed in host device 120, faceplate 122 in combination with flange 106 provides protection for bi-directional transceiver 100 against EMI.

Bi-directional transceiver 100 is approximately half the width of a standard small form factor transceiver as described in the Cooperation Agreement. Therefore, two bi-directional transceivers 100 can be installed in host device 120 in place of a single small form factor transceiver. By doubling the number of transceivers installed in a fixed area of host device 120, the port density of host device 120 is doubled. Doubling the port density by using bi-directional transceivers 100 reduces the cost of implementing a fiber optic transceiver system compared to a fiber optic transceiver system that uses standard small form factor transceivers.

What is claimed is:

1. A bi-directional transceiver comprising:
a housing;
a flange coupled to the housing; and
only one LC receptacle coupled to the housing,
wherein a width of the housing is less than 9.2 mm, and a width of the flange is less than 9.5 mm.

2. The bi-directional transceiver of claim 1, further comprising:
an interface coupled to the housing for electrically coupling the bi-directional transceiver to a host device.

3. The bi-directional transceiver of claim 2, wherein the interface is adapted for removably electrically coupling the bi-directional transceiver to the host device.

4. The bi-directional transceiver of claim 2, wherein the interface is adapted for soldering to a host interface board of the host device.

5. The bi-directional transceiver of claim 1, wherein a length of the housing is within a range of 45-49 mm.

6. The bi-directional transceiver of claim 1, wherein a height of the housing is within a range of 8-9 mm.

7. The bi-directional transceiver of claim 1, further comprising:
a latch coupled to the housing to mechanically couple the bi-directional transceiver to a host device.

8. The bi-directional transceiver of claim 1, wherein the flange provides protection for the bi-directional transceiver against electromagnetic interference with the bidirectional transceiver installed in a host.

9. A network device comprising:
a host device comprising:
a faceplate; and
a first opening in the faceplate, the first opening for receiving a first bi-directional transceiver; and
a first bi-directional transceiver installed in the first opening, the bi-directional transceiver comprising:
a housing;
a flange coupled to the housing; and
only one LC receptacle coupled to the housing,
wherein a width of the housing is less than a width of the flange, and the width of the flange is within a range of 8.5-9.5 mm.

10. The network device of claim 9, wherein the host device comprises a second opening in the faceplate adjacent the first opening, the second opening for receiving a second bi-directional transceiver, and wherein the center to center spacing between the first opening and the second opening is less than 10 mm.

11. The network device of claim 10, wherein a second bi-directional transceiver similar to the first bi-directional transceiver is installed in the second opening.

12. The network device of claim 11, wherein a port density of the network device is 100% greater than a port density of a network device using standard small form factor transceivers.

13. The network device of claim 9, wherein the first bi-directional transceiver is installed in the first opening such that the flange contacts the faceplate.

14. The network device of claim 13, wherein the flange and the faceplate provide protection for the first bi-directional transceiver against electromagnetic interference.

15. A method for using a bi-directional transceiver, the method comprising:
providing a housing;
providing a flange coupled to the housing; and
providing only one LC receptacle coupled to the housing,
wherein a width of the housing is less than 9.2 mm, and a width of the flange is less than 9.5 mm.

16. The method of claim 15, further comprising:
providing an interface coupled to the housing, the interface for electrically coupling the bi-directional transceiver to a host device.

17. The method of claim 16, further comprising:
installing the bi-directional transceiver in the host device such that the flange contacts a faceplate of the host.

18. The method of claim 17, wherein installing the bi-directional transceiver in the host device comprises installing the bi-directional transceiver in the host device such that the flange contacts the faceplate of the host to provide protection for the bi-directional transceiver against electromagnetic interference.

19. The method of claim 16, further comprising:
removably electrically coupling the interface to the host device.

20. The method of claim 16, further comprising:
soldering the interface to a host interface board of the host device.

21. A bi-directional transceiver comprising:
a housing;
a flange coupled to the housing for providing protection for the bi-directional transceiver against electromagnetic interference with the bi-directional transceiver installed in a host device;
only one LC receptacle coupled to the housing;
an interface coupled to the housing for electrically coupling the bi-directional transceiver to the host device; and
a latch coupled to the housing for mechanically coupling the bi-directional transceiver to the host device;
wherein a width of the housing is greater than or equal to a width of the LC receptacle and less than a width of a standard small form factor pluggable transceiver as described in the Cooperation Agreement.
